(19) United States
(12) Patent Application Publication
(10) Pub. No.: US 2016/0075826 A1
(43) Pub. Date: Mar. 17, 2016

(54) PROCESS FOR MANUFACTURING POLYAMIDE

(71) Applicants: AKRON POLYMER SYSTEMS, INC., Akron, OH (US); SUMITOMO BAKELITE COMPANY LIMITED, Shinagawa-ku (JP)

(72) Inventors: Limin SUN, Copley, OH (US); Dong Zhang, Uniontown, OH (US); Jiaokai Jing, Uniontown, OH (US); Frank W. Harris, Boca Raton, FL (US); Jun Okada, Kobe-shi (JP); Toshihiko Katayama, Nishinomiya-shi (JP); Hideo Umeda, Kobe-shi (JP); Ritsuya Kawasaki, Kobe-shi (JP)

(73) Assignees: AKRON POLYMER SYSTEMS, INC., Akron, OH (US); SUMITOMO BAKELITE COMPANY LIMITED, Shinagawa-ku (JP)

(21) Appl. No.: 14/849,065

(22) Filed: Sep. 9, 2015

Related U.S. Application Data
(60) Provisional application No. 62/048,977, filed on Sep. 11, 2014.

(51) Int. Cl. C08G 69/06

(52) U.S. Cl. CPC C08G 69/06

(57) ABSTRACT

In one or a plurality of embodiments, a process for manufacturing polyamide without using PrO (propylene oxide) in synthesis is provided. In one or a plurality of embodiments, provided is a process for manufacturing polyamide, including steps (a) to (c): (a) reacting diacid dichloride monomer with at least two kinds of diamine monomers in a solvent so as to generate polyamide; and (b) removing hydrochloric acid physically out of a reaction system, the hydrochloric acid being generated during the reaction in the step (a); or (c) adding a trapping reagent capable of trapping hydrochloric acid, at any time at least before the step (a), at the same time of starting the step (a), or during the step (a), wherein at least one of the diamine monomers is a diamine monomer containing a carboxyl group, and the trapping reagent does not include propylene oxide.

### CROSS-REFERENCE TO RELATED APPLICATION

The disclosure is based upon and claims priority from U.S. Provisional Application Ser. No. 62/048,977 filed on Sep. 11, 2014, the disclosure of which is hereby incorporated by reference herein in its entirety

### TECHNICAL FIELD

The present disclosure relates to a process for manufacturing polyamide.

### BACKGROUND

As transparency is required for display elements, glass substrates using glass plates have been used as substrates for the elements. However, for display elements using glass substrates, problems such as being heavy in weight, breakable and unbendable have been pointed out at times. Thus, use of a transparent resin film instead of a glass substrate has been proposed. For example, polycarbonates, which have high transparency, are known as transparent resins for use in optical applications. However, their heat resistance and mechanical strength may not be sufficient to be used for manufacturing display elements. On the other hand, examples of heat resistant resins include polyimides. However, typical polyimides are brown-colored, and thus it may not be suitable for use in optical applications. As polyimides with transparency, those having a ring structure are known. However, the problem with such polyimides is that they have poor heat resistance.

WO2012/129422 or JP 2014-508851A relates to aromatic polyamide films for transparent flexible substrates applied to microelectronic equipment. These documents disclose a method for synthesizing polyamide, including: dissolving diamine in an amide-based solvent (DMAc) and then adding diacid dichloride so as to form a gel; later adding PrO (propylene oxide) thereto, and pulverizing the gel so as to obtain a homogeneous polyamide solution.

### SUMMARY

In one or a plurality of embodiments, the present disclosure provides a process for manufacturing polyamide without using PrO (propylene oxide) as a hydrochloric acid trapping reagent in synthesis.

In one or a plurality of embodiments, the present disclosure relates to a process for manufacturing polyamide, comprising steps of: (a) reacting a diacid dichloride monomer with at least two kinds of diamine monomers in a solvent so as to generate polyamide; and (b) removing hydrochloric acid physically out of a reaction system, the hydrochloric acid being generated during the reaction in the step (a), wherein at least one of the diamine monomers is a diamine monomer containing a carboxyl group.

In another one or a plurality of embodiments, the present disclosure relates to a process for manufacturing polyamide, comprising steps of: (a) reacting a diacid dichloride monomer with at least two kinds of diamine monomers in a solvent so as to generate polyamide; and (c) adding a trapping reagent capable of trapping hydrochloric acid, at any time at least before the step (a), at the same time of starting the step (a), or during the step (a), wherein at least one of the diamine monomers is a diamine monomer containing a carboxyl group, and the trapping reagent does not include propylene oxide.

In one or a plurality of embodiments, the present disclosure relates to a polyamide solution manufactured by a manufacturing process according to the present disclosure, and relates to a process for manufacturing a display element, an optical element, an illumination element or a sensor element, comprising steps of

(I) applying a polyamide solution on a base to form a film, the solution being obtained or obtainable by the process according to the present disclosure; and

(II) forming the display element, the optical element, the illumination element, or the sensor element on one surface of the polyamide film.

According to the present disclosure, in one or a plurality of embodiments, it is possible to provide a process for manufacturing polyamide without using a hydrochloric acid trapping reagent or without using PrO (propylene oxide) as a hydrochloric acid trapping reagent in a polyamide polymerization reaction.

### BRIEF DESCRIPTION OF DRAWINGS

FIG. 1 is a schematic view for explaining a process for manufacturing an OLED element or a sensor element according to one embodiment.

FIG. 2 is a schematic cross-sectional view showing a configuration of an organic EL element 1 according to one embodiment.

FIG. 3 is a schematic cross-sectional view showing a sensor element 10 according to one embodiment.

### DETAILED DESCRIPTION

In a case of polymerization reaction between a diacid dichloride monomer and at least two kinds of diamine monomers in a solvent so as to synthesize polyamide, hydrochloric acid generated due to the polymerization reaction and the diamine form hydrochloride to result in a state of white turbidity or gelation to slow down the polymerization reaction. For solving the problem, in general, propylene oxide (PrO) for trapping hydrochloric acid is added to a reaction solution. The propylene oxide is often called a trapping reagent.

Since a reaction product (chloropropanol) between the propylene oxide and the hydrochloric acid is dissolved in the solvent, purification of the polyamide is carried out in general for the purpose of removing the reaction product from the polyamide solution after a synthesis reaction. The present disclosure is based on a finding that, in one or a plurality of embodiments, the cost for purification can be reduced if a use of propylene oxide is avoidable, and thus the cost for manufacturing polyamide can be reduced. Further, the present disclosure is based on a finding that, in one or a plurality of embodiments, hazardousness in manufacturing polyamide can be reduced if a use of highly-inflammable propylene oxide is avoidable.

Therefore, the present disclosure relates to a process for manufacturing polyamide, the process includes reacting a diacid dichloride monomer with at least two kinds of diamine monomers in a solvent so as to obtain polyamide without using propylene oxide (this is expressed also as a “manufacturing process according to the present disclosure”).

[First Manufacturing Process]

A first embodiment of a manufacturing process according to the present disclosure is a process for manufacturing polyamide, comprising steps of: (a) reacting a diacid dichloride monomer with at least two kinds of diamine monomers in a solvent so as to generate polyamide; and (b) removing hydrochloric acid physically out of a reaction system, the hydrochloric acid being generated during the reaction in the step (a), wherein at least one of the diamine monomers is a diamine monomer containing a carboxyl group.

In one or a plurality of embodiments, it is preferable from the viewpoint of promoting the polymerization reaction of polyamide, that the step (b) in the first embodiment of the manufacturing process according to the present disclosure is conducted in a continuous or intermittent manner at a timing where generation of the hydrochloric acid starts during the step (a).

In one or a plurality of embodiments, one example of “removing hydrochloric acid physically out of a reaction system” in the step (b) is volatilization of the hydrochloric acid by pressure reduction, heating or both thereof so as to form hydrogen chloride (hydrochloride gas) and dispose of the hydrogen chloride with a scrubber. In another one or a plurality of embodiments, the atmospheric pressure inside the reaction system is set to 3.0 kPa or in a range of 2.5 to 3.5 kPa by a rotary pump or a diaphragm pump so as to volatilize the generated hydrochloric acid and physically remove the hydrochloric acid.

It is possible to remove and separate the hydrochloric acid by conducting the step (b). Therefore, as a result of conducting the step (b), it is possible to avoid a purification step of separating the dissolved polyamide and the dissolved propylene chloride so as to reduce the cost for purification.

[Second Manufacturing Process]

A second embodiment of a manufacturing process according to the present disclosure is a process for manufacturing polyamide, comprising steps of: (a) reacting a diacid dichloride monomer with at least two kinds of diamine monomers in a solvent so as to generate polyamide; and (c) adding a trapping reagent capable of trapping hydrochloric acid, at any time at least before the step (a), at the same time of starting-the step (a), or during the step (a), wherein-at least one of the diamine monomers is a diamine monomer containing a carboxyl group, and the trapping reagent does not contain propylene oxide.

The step (c) in the second embodiment of the manufacturing process according to the present disclosure is a step of removing hydrochloric acid by using a hydrochloric acid trapping reagent other than propylene oxide. In one or a plurality of embodiments, examples of the trapping reagent include an organic base, an inorganic base or a combination thereof. In one or a plurality of embodiments, examples of the organic base include: aliphatic tertiary amines such as trimethylamine, triethylamine, tripropylamine and tributylamine; and cyclic organic bases such as pyridine, lutidine, collidine and quinoline. In one or a plurality of embodiments, examples of the inorganic base include inorganic bases such as an alkali metal hydroxide, an alkali metal carbonate, an alkali metal acetate, an alkaline earth metal oxide, an alkaline earth metal hydroxide, an alkaline earth metal carbonate, and an alkaline earth metal acetate. Specific examples thereof include potassium carbonate and sodium hydrogen carbonate.

Addition of the trapping reagent during the step (c) may be conducted at any time at least before the step (a), at the same time of starting the step (a), or during the step (a). In one or a plurality of embodiments, addition of the trapping reagent may be conducted during sequential addition of the diacid dichloride monomer or the diamine monomers in the step (a), or after adding all of the diacid dichloride monomer and the diamine monomers. The trapping reagent may be added in parts.

In one or a plurality of embodiments, from the viewpoint of promoting the reaction and the viewpoint of improving the efficiency in hydrochloric acid removal, the addition amount of the trapping reagent in the step (c) is preferably greater than the mole number of the diamine monomers used in the step (a), more preferably, 2.0 times or more of the mole number of the diamine monomer, and further preferably 3.0 times or more of the mole number of the diamine monomer. In one or a plurality of embodiments, from the viewpoint of reducing the use amount, the addition amount of the trapping reagent is 6.0 times or less of the mole number of the diamine monomer, more preferably 5.0 time or less, and further preferably 4.0 times or less.

As a result of conducting the step (c), the trapping reagent and the hydrochloric acid generated in the polymerization reaction form hydrochloride and precipitate. The hydrochloride can be separated from the solution of the synthesized polyamide by only filtering. Therefore, the step (c) makes it possible to avoid a purification step of separating the dissolved polyamide and the dissolved chloropropanol, thereby reducing the purification cost.

[Solvent]

In one or a plurality of embodiments, examples of the solvent to be used in the step (a) of the manufacturing process (including the first and second embodiments) according to the present disclosure include a non-amide-based organic solvent, an amide-based organic solvent, or a combination thereof. In one or a plurality of embodiments, from the viewpoint of reducing the environmental load, it is preferable that in the manufacturing process according to the present disclosure, use of the amide-based organic solvent is reduced, and more preferably an amide-based organic solvent is not used.

[Non-Amide-Based Organic Solvent]

In one or a plurality of embodiments, the non-amide-based organic solvent is a non-protic solvent, and furthermore in one or a plurality of embodiments, γ-butyrolactone, α-methyl-γ-butyrolactone, or a mixture thereof is preferred from the viewpoint of reducing the use of an amide-based solvent in the polyamide polymerization reaction.

[Amide-Based Organic Solvent]

In one or a plurality of embodiments, examples of the amide-based solvent include: N,N-dimethylacetamide (DMAc), N-methyl-2-pyrrolidone (NMP), N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, and a combination thereof.

[Diacid Dichloride Monomer]

The diacid dichloride monomer used in the manufacturing process according to the present disclosure is not limited in particular but it may include any known diacid dichloride that is used and will be used as a monomer for synthesizing a polyamide film. In one or a plurality of embodiments, from the viewpoint of manufacturing polyamide to be used in a polyamide film used for an electronic part such as a display element, an optical element, an illumination element or a sensor element, the diacid dichloride may be selected from the group consisting of:

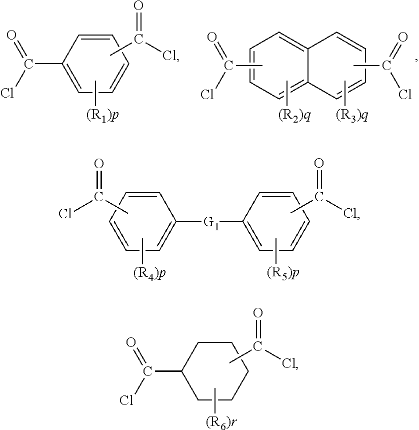

and a combination thereof.

In the above formulae for diacid dichloride monomer, p=4, q=3, r=10, and wherein R₁, R₂, R₃, R₄, R₅ and R₆ are selected from the group consisting of hydrogen, halogen (fluoride, chloride, bromide, and iodide), alkyl, substituted alkyl such as halogenated alkyl, nitro, cyano, thioalkyl, alkoxy, substituted alkoxy such as a halogenated alkoxy, aryl, substituted aryl such as halogenated aryl, alkyl ester and substituted alkyl ester such as halogenated alkyl ester, and combinations thereof. It is to be understood that each R₁ can be different, each R₂ can be different, each R₃ can be different, each R₄ can be different, each R₅ can be different, and each R₆ can be different. G₁ is selected from the group consisting of a covalent bond; a CH₂ group; a (CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group, such as a phenyl group, a biphenyl group, a perfluorobiphenyl group, a 9,9-bisphenylfluorene group, and a substituted 9,9-bisphenylfluorene group.

Of these, in one or a plurality of embodiments, examples of the diacid dichloride monomer may include: terephthaloyl dichloride, isophthaloyl dichloride, 2,6-naphthaloyl dichloride, 4,4′-biphenyldicarbonyl dichloride, and, tetrahydro terephthaloyl dichloride, and a combination thereof, from the viewpoint of manufacturing any polyamide to be used for a polyamide film used in an electronic part such as a display element, an optical element, an illumination element, a sensor element or the like.

[Diamine Monomer]

The diamine monomers to be used in the manufacturing process according to the present disclosure are not limited in particular, but any known diamine that is used or will be used as a monomer for synthesis of a polyamide film is employed. In one or a plurality of embodiments, from the viewpoint of manufacturing polyamide to be used for a polyamide film used in an electronic part such as a display element, an optical element, an illumination element, a sensor element or the like, the diamine may be selected from the group consisting of:

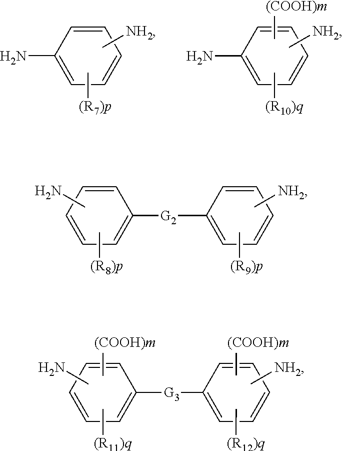

and a combination thereof.

In the above formulae for diamine, p=4, q=2 or 3, m=1 or 2, and wherein R₇, R₈, R₉, R₁₀, R₁₁, and R₁₂ are selected from the group consisting of hydrogen, halogen (fluoride, chloride, bromide, and iodide), alkyl, substituted alkyl such as halogenated alkyl, nitro, cyano, thioalkyl, alkoxy, substituted alkoxy such as a halogenated alkoxy, aryl, substituted aryl such as halogenated aryl, alkyl ester and substituted alkyl ester such as halogenated alkyl ester, and combinations thereof. It is to be understood that each R₇ can be different, each R₈ can be different, each R₉ can be different, each R₁₀ can be different, each Ru can be different, and each R₁₂ can be different. G₂ and G₃ each is selected from the group consisting of a covalent bond; a CH₂ group; a C(CH₃)₂ group aC(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group, such as a phenyl group, a biphenyl group, a perfluorobiphenyl group, a 9,9-bisphenylfluorene group, and a substituted 9,9-bisphenylfluorene group.

Of these diamine monomers, from the viewpoint of manufacturing polyamide to be used for a polyamide film used in an electronic part such as a display element, an optical element, an illumination element or a sensor element, it is preferable to use at least two kinds of diamine monomers. Two, three, four or more kinds of diamine monomers may be used. From a similar viewpoint, in the manufacturing process according to the present disclosure, at least one of the diamine monomers is a diamine monomer containing a carboxyl group.

In one or a plurality of embodiments, from the viewpoint of manufacturing polyamide to be used for a polyamide film used in an electronic part such as a display element, an optical element, an illumination element, a sensor element or the like, examples of the diamine monomer may be 4,4′-diamino-2,2′-bistrifluoromethylbenzidine, 9,9-bis(4-aminophenyl)fluorene, 9,9-bis(3-fluoro-4-aminophenyl)fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, 3,5-diaminobenzoic acid, bis(4-aminophenyl)sulfone (DDS), and a combination thereof.

[Method of Adding Monomer]

In one or a plurality of embodiments, one example of the methods for adding and reacting the diacid dichloride monomer with at least two kinds of diamine monomers in the step (a) is a method of dissolving in advance either the diacid dichloride monomer or the diamine monomers in the solvent and adding the other monomer(s) to the solution so as to conduct a polymerization reaction.

For a method of adding diacid dichloride monomer to the solution of the diamine monomers for polymerization reaction, the diacid dichloride monomer may be added in several parts for the purpose of suppressing abrupt heating in one or a plurality of embodiments. In one or a plurality of embodiments, the diacid clichtoride monomer to be added may be in a state of powder from the viewpoint of solubility, but it may be a mass or in a state molten by heat. In one or a plurality of non-limiting embodiments, the frequency of addition may be 2 to 10, or 3 to 5. In one or a plurality of embodiments, the reaction system in the step (a) may be cooled, or the temperature may be lowered or kept to be higher than 0° C. and not higher than 50° C., or in the range of 3° C. to 40° C., or 4° C. to 10° C., from the viewpoint of suppressing temperature rise caused by the reaction heat.

From the viewpoint of suppressing abrupt heating in one or a plurality of embodiments, in a method of adding diamine monomers to the solution of the diacid dichloride monomer for polymerization reaction, the diamine monomers may be added in several parts. In one or a plurality of embodiments, the diamine monomers to be added may be in a state of powder from the viewpoint of solubility, but they may be a mass or in a state molten by heat. In one or a plurality of non-limiting embodiments, the frequency of addition may be 2 to 10, or 3 to 5. In one or a plurality of embodiments, the reaction system in the step (a) may be cooled, or the temperature may be lowered or kept to be higher than 0° C. and not higher than 50° C., or in the range of 3° C. to 40° C., or 4° C. to 10° C., from the viewpoint of suppressing temperature rise caused by the reaction heat.

[Method of Adding Trapping Reagent]

In one or a plurality of embodiment, at least one of the monomers to be added may be added in several parts as mentioned above in the step (c) of the second manufacturing process from the viewpoint of promoting the polymerization reaction, and the trapping reagent may be added after or during addition of at least a part of the monomer. Or the trapping reagent may be added after addition of at least a part of the monomer. In one or a plurality of embodiments, the amount of at least a part of the monomer may be 80 to 100 mol %, 90 to 100 mol %, or 95 to 100 mol % with respect to the whole diacid dichloride to be added. In one or a plurality of embodiments, an example of the method for adding the trapping reagent may be: adding the diacid dichloride in parts as mentioned above; and adding the trapping reagent at a timing the reaction solution turns to whitish after or during the addition of the diacid dichloride. In one or a plurality of embodiments, the total amount of the added monomer can be determined appropriately such that a finally obtained polyamide solution will achieve a desired viscosity. In one or a plurality of embodiments, the amount of the trapping reagent to be added may be within the above-mentioned range.

According to the manufacturing process of the present disclosure, in one or a plurality of embodiments, it is possible to synthesize polyamide in a state of being dissolved in a solvent, i.e., as a polyamide solution.

In one or a plurality of embodiments of the present disclosure, from the viewpoint of enhancement of heat resistance property of the polyamide film, the manufacturing process according to the present disclosure further comprises the step of end-capping of one or both of terminal —COOH group and terminal —NH₂ group of the polyamide. The terminal of the polyamide can be end-capped by the reaction of polymerized polyamide with benzoyl chloride when the terminal of polyamide is —NH_{2,} or reaction of polymerized polyamide with aniline when the terminal of polyamide is —COOH. However, the method of end-capping is not limited to this method.

In one or a plurality of embodiments, the manufacturing process according to the present disclosure can be conducted in the absence of inorganic salt from the viewpoint of using the polyamide solution for manufacturing a display element, an optical element, an illumination element or a sensor element.

In one or a plurality of embodiments in the manufacturing process according to the present disclosure, from the viewpoint of using the polyamide solution in the process for manufacturing a display element, an optical element, an illumination element or a sensor element, the synthesized polyamide in the polyamide solution is precipitated and re-dissolved in a solvent, thereby a polyamide solution dissolved in a solvent afresh can be obtained. The precipitation can be carried out by a typical method. In one or a plurality of embodiments, by adding the polyamide to methanol, ethanol, isopropyl alcohol or the like, it is precipitated, cleaned, and dissolved in the solvent, for example.

[Solvent for Re-Dissolution]

In one or a plurality of embodiments of the present disclosure, from the viewpoint of enhancement of solubility of the polyamide to the solvent, the solvent for re-dissolution may be a polar solvent or a mixed solvent comprising one or more polar solvents. In one or a plurality of embodiments of the present disclosure, from the viewpoint of enhancement of soluiblity of the polyimide to the solvent and from the viewpoint of enhancing adhesiveness of the polyamide film to a base, the polar solvent may be methanol, ethanol, propanol, isopropanol (IPA), butanol, acetone, methyl ethyl ketone (MEK), methyl isobutyl ketone (MIBK), toluene, cresol, xylene, propyleneglycol monomethyl ether acetate (PGMEA), N,N-dimethylacetamide (DMAc) or N-methyl-2-pyrrolidone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-butoxy-N,N-dimethylpropanamide, 1-ethyl-2-pyrrolidone, N,N-dimethylpropanamide, 1-methyl-2-piperidinone, propylene carbonate, and a combination thereof, or a mixed solvent comprising at least one of the solvents.

[Polyamide Solution]

In another aspect, the present disclosure relates to a polyamide solution, namely, a solution containing polyimide manufactured by the manufacturing process according to the above-mentioned present disclosure (hereinafter, this is expressed also as “polyamide solution according to the present disclosure”). The solvent in the polyamide solution according to the present disclosure may be the solvent used during the synthesis, or it may be the solvent used in the re-dissolution.

[Content of Polyamide]

In one or a plurality of embodiments, the content of the polyamide in the polyamide solution according to the present disclosure may be 2% by weight or more, 3% by weight or more, or, 5% by weight or more from the viewpoint of use of the film for a display element, an optical element, an illumination element or a sensor element. From a similar viewpoint, it may be 30% by weight or less, 20% by weight or less, or, 15% by weight or less.

In one or a plurality of embodiments, the polyamide solution according to the present disclosure may contain inorganic filler.

In one or a plurality of embodiments, the polyamide solution according to the present disclosure is a polyamide solution to be used in a process for manufacturing a display element, an optical element, an illumination element or a sensor element

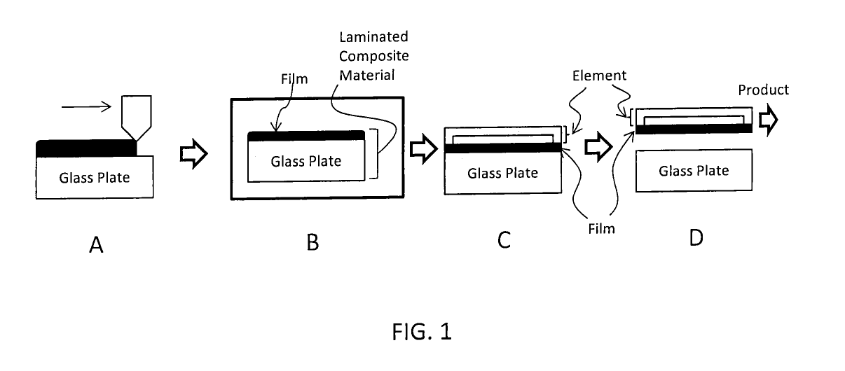

A display element, an optical element, or an illumination element such as an organic electro-luminescence (OEL) or organic light-emitting diode (OLED) is often produced by the process as described in FIG. 1. Briefly, a polymer solution (varnish) is applied or casted on a glass base or a silicon wafer base (step A), the applied polymer solution is cured to form a film (step B), an element such as OLED is formed on the film (step C), and then, the element such as OLED or a sensor element (product) is de-bonded from the base (step D). In one or a plurality of embodiments, the polyamide solution according to the present disclosure can be used as the polymer solution (varnish).

[Process for Manufacturing Display Element, Optical Element, Illumination Element or Sensor Element]

Therefore, in another aspect, the present disclosure relates to a process for manufacturing a display element, an optical element, an illumination element or a sensor element, including the steps (I) and (II) below (hereinafter, this is expressed also as “process for manufacturing an element according to the present disclosure”):

(I) applying a polyamide solution on a base so as to form a film, the solution being obtained or obtainable by the process according to the present disclosure; and

(II) forming the display element, the optical element, the illumination element, or the sensor element on one surface of the polyamide film.

In one or a plurality of embodiments, the base or the surface thereof is composed of glass or silicon wafer.

In one or a plurality of embodiments, the process for manufacturing an element according to the present disclosure includes further a step of de-bonding the thus formed display element, optical element, illumination element or sensor element from the base.

[Laminated Composite Material]

The term “laminated composite material” as used herein refers to a material in which a base and a polyamide resin layer are laminated. In one or a plurality of non-limiting embodiments, a base and a polyamide resin layer being laminated indicates that the base and the polyamide resin layer are laminated directly Alternatively, in one or aplurality of non-limiting embodiments, it indicates that the base and the polyamide resin layer are laminated via one or a plurality of layers.

In one or a plurality of non-limiting embodiments, the laminated composite material can be used in a process for manufacturing a display element, an optical element, an illumination element or a sensor element, such as the one illustrated in FIG. 1. Further in one or a plurality of non-limiting embodiments, it can be used as a laminated composite material obtained in the step B of the manufacturing process illustrated in FIG. 1. Therefore, in another aspect, the present disclosure relates to a laminated composite material including a polyamide resin layer laminated on one surface of a glass plate, wherein the polyamide resin of the polyamide resin layer is formed by the manufacturing process according to the present disclosure.

In one or a plurality of embodiments, the laminated composite material according to the present disclosure is a laminated composite material to be used for a process for manufacturing a display element, an optical element, an illumination element or a sensor element, the process including formation of a display element, an optical element or an illumination element, or a sensor element on a surface of the polyamide resin layer which is opposite to the surface facing the glass plate.

In one or a plurality of embodiments, the laminated composite material according to the present disclosure may include additional organic resin layers and/or inorganic layers in addition to the polyamide resin layer. In one or a plurality of non-limiting embodiments, examples of additional organic resin layers include a flattened coat layer. Further, in one or a plurality of non-limiting embodiments, examples of inorganic layers include a gas barrier layer capable of suppressing permeation of water or oxygen and a buffer coat layer capable of suppressing migration of ions to a TFT element.

[Thickness of Polyamide Resin Layer]

In one or a plurality of embodiments, from the viewpoint of using the film in a display element, an optical element, an illumination element or a sensor element and suppressing the development of cracks in the resin layer, the polyamide resin layer of the laminated composite material according the present disclosure has a thickness of 500 μm or less, 200 μm or less, or 100 μm or less. Further, in one or a plurality of non-limiting embodiments, the polyamide resin layer has a thickness of 1 μm or more, 2 μm or more, or 3 μm or more, for example.

[Transmittance of Polyamide Resin Layer]

In one or a plurality of embodiments, the polyamide resin layer of the laminated composite material according to the present disclosure has a total light transmittance of 70% or more, 75% or more, or 80% or more from the viewpoint of allowing the laminated composite material to be used suitably in manufacturing a display element, an optical element, an illumination element or a sensor element.

[Base]

In one or a plurality of embodiments, from the viewpoint of using the film in a display element, an optical element, an illumination element or a sensor element, the material of the base of the laminated composite material according to the present disclosure may be, for example, glass, soda-lime glass, non-alkali glass, silicon wafer or the like. In one or a plurality of embodiments, from the viewpoint of using the film in a display element, an optical element, an illumination element or a sensor element, the base of the laminated composite material according the present disclosure has a thickness of 0.3 mm or more, 0.4 mm or more, or 0.5 mm or more. Further, in one or a plurality of embodiments, the base has a thickness of 3 mm or less or 1 mm or less, for example.

[Process for Manufacturing Laminated Composite Material]

In one or a plurality of non-limiting embodiments, the laminated composite material according to the present disclosure can be manufactured by applying the polyamide solution according to the present disclosure on a glass plate, and drying, and if necessary curing, the applied solution. Therefore, in one or a plurality of embodiments of the present disclosure, the present disclosure relates to a process for manufacturing the laminated composite material including the steps of

i) applying a polyamide solution on a base, the polyamide solution being obtained or obtainable by the manufacturing process according to the present disclosure; and

ii) heating the casted polyamide solution to form a polyamide film after the step (i).

In one or a plurality of embodiments, the process for manufacturing an element according to the present disclosure is a manufacturing process including a step of forming a display element, an optical element, or an illumination element or a sensor element on a surface of the polyamide resin layer of the laminated composite material according to the present disclosure, i.e., a surface opposite to the surface facing the glass plate. In one or a plurality of embodiments, the manufacturing process further includes the step of de-bonding the thus formed display element, the optical element, the illumination element or the sensor element from the glass plate.

[Display Element, Optical Element, or Illumination Element]

The term “a display element, an optical element, or an illumination element” as used in the present disclosure refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or a plurality of embodiments, the display element, the optical element or the illumination element according to the present disclosure includes what is manufactured by using the polyamide solution according to the present disclosure, and/or what is manufactured by using the laminated composite material according to the present disclosure, and/or what is manufactured by the process for manufacturing an element according to the present disclosure.

<Non-Limiting Embodiment of Organic EL Element>

Hereinafter, one embodiment of an organic EL element as one embodiment of the display element according to the present disclosure will be described with reference to the drawing.

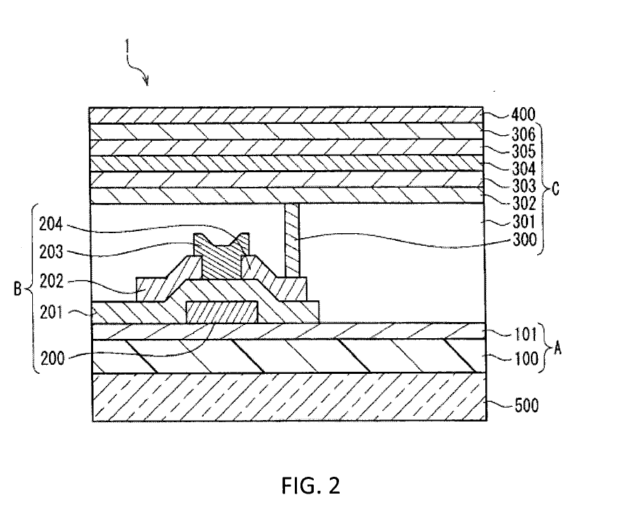

FIG. 2 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separated from a base 500 or may include the base 500. Hereinafter, each component will be described in detail.

1, Substrate A

The substrate A includes a transparent resin substrate 100 and a gas barrier layer 101 formed on top of the transparent resin substrate 100. Here, the transparent resin substrate 100 is a film formed from the polyamide solution according to the present disclosure. The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum film formation method such as sputtering, CVD, vacuum deposition or the like. Generally, the gas barrier layer 101 has a thickness of, but is not limited to, about 10 nm to 100 nm. Here, the gas barrier layer 101 may be formed on a surface of the transparent resin substrate 100 facing the gas barrier layer 101 in

FIG. 2 or may be formed on the both surfaces of the transparent resin substrate 100.

2. Thin Film Transistor

The thin film transistor B includes a gate electrode 200, a gate insulating film 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vacuum deposition, ion plating or the like may be used to form these transparent thin films Generally, these electrodes have a film thickness of, but is not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL Layer

The organic EL layer C includes a conductive connector 300, an insulative flattened layer 301, a lower electrode 302 as the anode of the organic EL element 1, a hole transport layer 303, a light-emitting layer 304, an electron transport layer 305, and an upper electrode 306 as the cathode of the organic EL element 1. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 and the source electrode 202 of the thin film transistor B may be connected to each other through the connector 300.

The lower electrode 302 is the anode of the organic EL element 1, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 306 is a film composed of a layer of lithium fluoride (LiF) having a film thickness of 5 nm to 20 nm and a layer of aluminum (Al) having a film thickness of 50 nm to 200 nm. For example, vacuum deposition may be used to form the film.

When producing a bottom emission type organic EL element, the upper electrode 306 of the organic EL element 1 may be configured to have optical reflectivity. Thereby, the upper electrode 306 can reflect, in the display side direction, light generated by the organic EL element A and traveled toward the upper side as the opposite direction to the display side. Since the reflected light is also utilized for a display purpose, the emission efficiency of the organic EL element can be improved.

<Non-Limiting Embodiment of Process of Manufacturing Organic EL Element>

As one embodiment of the process of manufacturing a display element according to the present disclosure, hereinafter, one embodiment of a process of manufacturing an organic EL element will be described with reference to the drawing.

A method of producing the organic EL element 1 shown in FIG. 2 includes a fixing step, a gas barrier layer production step, a thin film transistor production step, an organic EL layer production step, a sealing step and a de-bonding step. Hereinafter, each step will be described in detail.

1. Fixing Step

In the fixing step, the transparent resin substrate 100 is fixed onto the base 500. Away to fix the transparent resin substrate to the base is not particularly limited. For example, an adhesive may be applied between the base 500 and the transparent resin substrate 100, or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like on the base 500 and placing the transparent resin substrate 100 on the applied releasing agent. In one or a plurality of embodiments, the polyamide film 100 is formed by applying the polyamide solution according to the present disclosure on the base 500, and for example drying the applied solution.

2. Gas Barrier Layer Production Step

In the gas barrier layer production step, the gas barrier layer 101 is produced on the transparent resin substrate 100. Away to produce the gas barrier layer 101 is not particularly limited, and a known method can be used.

3. Thin Film Transistor Production Step

In the thin film transistor production step, the thin film transistor B is produced on the gas barrier layer. Away to produce the thin film transistor B is not particularly limited, and a known method can be used.

4. Organic EL Layer Production Step

The organic EL layer production step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of, but is not limited to, about 100 nm to 2 μm.

In the second step, first, the connector 300 and the lower electrode 302 are formed at the same time. Sputtering, vacuum deposition, ion plating or the like may be used to form the connector 300 and the lower electrode 302. Generally, each of these electrodes has a film thickness of, but is not limited to, about 50 nm to 200 nm. Subsequently, the hole transport layer 303, the light-emitting layer 304, the electron transport layer 305, and the upper electrode 306 as the cathode of the organic EL element 1 are formed. To form these components, a method such as vacuum deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element 1.

5. Sealing Step

In the sealing step, the organic EL layer C is sealed with the sealing member 400 from top of the upper electrode 306. For example, a glass material, a resin material, a ceramics material, a metal material, a metal compound or a composite thereof can be used to form the sealing member 307, and a material best suited to the sealing member 400 can be chosen as appropriate.

6. De-Bonding Step

In the de-bonding step, the produced organic EL element 1 is de-bonded from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the production of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any-of these methods may be used in combination of two or more. Especially in one or a plurality of embodiments, the strength of adhesion between the polyamide film and the base can be controlled by a silane coupling agent, so that the organic EL element 1 can be physically stripped without using the complicated method such as described above.

[Display Device, Optical Device, and Illumination Device]

An aspect of the present disclosure relates to a display device, an optical device, or an illumination device using the display element, the optical element, or the illumination element according to the present disclosure, or a process of manufacturing the display device, the optical device, or the illumination device. Examples of the display device include, but are not limited to, an imaging element; examples of the optical device include, but are not limited to, a photoelectric complex circuit; and examples of the illumination device include, but are not limited to, a TFT-LCD and OEL illumination.

[Sensor Element]

In non-limiting one or a plurality of embodiments, a “sensor element” according to the present disclosure refers to a sensor element comprising a polyamide film formed of a polyamide solution used in the manufacturing process of the present disclosure. Further, in another one or a plurality of embodiments, a “sensor element” according to the present disclosure is a sensor element to be formed on a polyamide film formed on a base, and in any further one or a plurality of embodiments, it is a sensor element to be de-bonded from the base as required. In one or a plurality of embodiments, examples of the sensor element include a sensor element capable of receiving an electromagnetic wave, a sensor element capable of detecting a magnetic field, a sensor element capable of detecting the change in capacitance, or a sensor element capable of detecting the change in pressure. In one or a plurality of embodiments, examples of the sensor element include an imaging element, a radiation sensor element, a photo-sensor element, a magnetic sensor element, a capacitance sensor element, a touch sensor element, or a pressure sensor element and the like. In one or a plurality of embodiments, examples of the radiation sensor element include an X-ray sensor element. In one or a plurality of embodiments, the sensor elements according to the present disclosure include what is manufactured by using the polyamide solution according to the present disclosure, and/or what is manufactured by using the laminated composite material according to the present disclosure, and/or what is manufactured by the method for manufacturing an element according to the present disclosure. Further, in one or a plurality of embodiments, formation of a sensor element according to the present disclosure includes formation of a photoelectric conversion element and a driver element therefor.

In non-limiting one or a plurality of embodiments, a “sensor element” to be manufactured by the manufacturing process according to the present disclosure can be used in an input device, and in one or a plurality of embodiments, examples of the input device include optical, imaging, magnetic, capacitance, or pressure input device. In non-limiting one or a plurality of embodiments, examples of the input device include a radiograph device, a visible-light imaging device, a magnetic sensor device, a touch panel, a fingerprint recognition panel, an illuminant using a piezoelectric element, and the like. In one or a plurality of embodiments, examples of the radiograph device include an X-ray imaging device. Furthermore, in non-limiting one or a plurality of embodiments, the input device according to the present disclosure may have functions of an output device, such as a display function. Therefore, in the aspect, the present disclosure relates to an input device using a sensor element manufactured by the manufacturing method in this aspect, and also relates to a method for manufacturing the same.

<Non-Limiting Embodiment for Sensor Element>

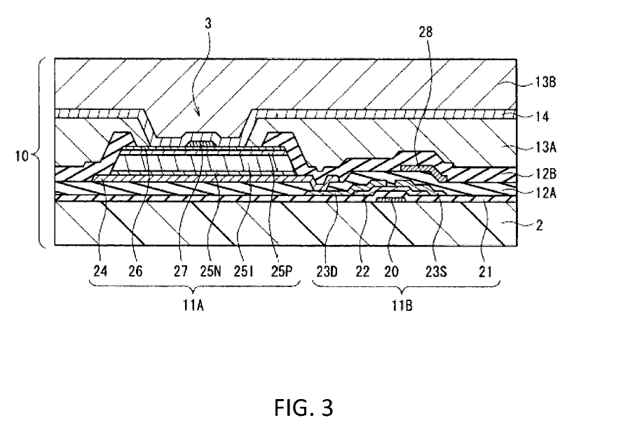

Hereinafter, an embodiment of sensor element that can be manufactured by the manufacturing method in this aspect are explained with reference to FIG. 3.

FIG. 3 is a schematic cross-sectional view showing a sensor element 10 according to an embodiment. The sensor element 10 has a plurality of pixels. This sensor element 10 is produced by forming, on a surface of a substrate 2, a pixel circuit including a plurality of photodiodes 11A (photoelectric conversion element) and a thin film transistor (TFT) 11B as the driver element for the photodiodes 11A. This substrate 2 is the polyamide film to be formed on a base (not shown) by the step (A) of the manufacturing process in this aspect. And in the step (B) of the manufacturing process in this aspect, the photodiodes 11A (photoelectric conversion element) and the thin film transistor 11B as the driver element for the photodiodes 11A are formed.

A gate insulating film 21 is provided on the substrate 2, and it is composed of a single layer film of any one of a silicon oxide (SiO₂) film, a silicon oxynitride (SiON) film and a silicon nitride (SiN) film for example, or a laminated film of two or more of them. A first interlayer insulating film 12A is provided on the gate insulating film 21, and it is composed of a silicon oxide film or a silicon nitride film etc. This first interlayer insulating film 12A functions also as a protective film (passivation film) to cover the top of the thin film transistor 11B described below.

(Photodiode 11A)

The photodiode 11A is disposed on a selective region of the substrate 2 via the gate insulating film 21 and the first interlayer insulating film 12A. Specifically, the photodiode 11A is prepared by laminating, on the first interlayer insulating film 12A, a lower electrode 24, a n-type semiconductor layer 25N, an i-type semiconductor layer 25I, a p-type semiconductor layer 25P and an upper electrode 26 in this order. The upper electrode 26 is an electrode for supplying a reference potential (bias potential) during a photoelectric conversion for example to the above-mentioned photoelectric conversion layer, and thus it is connected to a wiring layer 27 as a power supply wiring for supplying the reference potential. This upper electrode 26 is composed of a transparent conductive film of ITO (indium tin oxide) or the like, for example.

(Thin Film Transistor 11B)

The thin film transistor 11B is composed of a field effect transistor (FET), for example. This thin film transistor 11B is prepared by forming on the substrate 2 a gate electrode 20 composed of titanium (Ti, Al, Mo, tungsten (W), chromium (Cr) and the like, and by forming the above-mentioned gate insulating film 21 on this gate electrode 20. Further, a semiconductor layer 22 is formed on the gate insulating film 21, and the semiconductor layer 22 has a channel region. On this semiconductor layer 22, a source electrode 23S and a drain electrode 23D are formed. Specifically, here, the drain electrode 23D is connected to the lower electrode 24 in each photodiode 11A while the source electrode 23S is connected to a relay electrode 28.

Furthermore in the sensor element 10, on such photodiode 11A and the thin film transistor 11B, a second interlayer insulating film 12B, a first flattened film 13A, a protective film 14 and a second flattened film 13B are provided in this order. Further in this first flattened film 13A, an opening 3 is formed corresponding to the region for forming the photodiode 11A.

On the sensor element 10, for example, a wavelength conversion member is formed to produce a radiograph device.

Regarding the above-mentioned embodiments, the present disclosure further discloses compositions, manufacturing processes and applications below.

<1> A process for manufacturing polyamide, comprising steps of: (a) reacting a diacid dichloride monomer with at least two kinds of diamine monomers in a solvent so as to generate polyamide; and (b) removing hydrochloric acid physically out of a reaction system, the hydrochloric acid being generated during the reaction in the step (a), wherein at least one of the diamine monomers is a diamine monomer containing a carboxyl group.

<2> A process for manufacturing polyamide, comprising steps of: (a) reacting a diacid dichloride monomer with at least two kinds of diamine monomers in a solvent so as to generate polyamide; and (c) adding a trapping reagent capable of trapping hydrochloric acid, at any time at least before the step (a), at the same time of starting the step (a), or during the step (a), wherein at least one of the diamine monomers is a diamine monomer containing a carboxyl group, and the trapping reagent contains no propylene oxide.

<3> The process according to <2>, wherein the trapping reagent is either an organic base or an inorganic base.

<4> The process according to any one of <1> to <3>, wherein the solvent is a non-amide-based organic solvent, an amide-based organic solvent, or a combination thereof.

<5> The process according to any one of <1> to <4>, wherein the polyamide is obtained as a polyimide solution where the polyamide is dissolved in a solvent.

<6> The process according to any one of <1> to <5>, wherein the diacid dichloride monomer is selected from the group consisting of

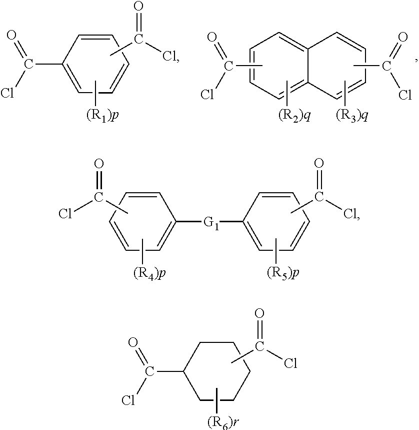

and a combination thereof, wherein p=4, q=3, r=10, and wherein R₁, R₂, R₃, R₄, R₅ and R₆ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof wherein G₁ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

<7> The process according to any one of <1> to <6>, wherein the diacid dichloride monomer is selected from the group consisting of terephthaloyl dichloride, isophthaloyl dichloride, 2,6-naphthaloyl dichloride, 4,4′-biphenyldicarbonyl dichloride, tetrahydro terephthaloyl dichloride and a combination thereof.

<8> The process according to any one of <1> to <7>, wherein the diamine monomers are selected from the group consisting of

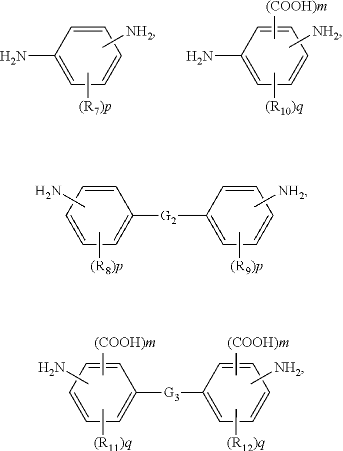

and a combination thereof,

wherein p=4, q=2 or 3, m=1 or 2, and wherein R₇, R₈, R₉, R₁₀, R₁₁ and R₁₂ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof;

wherein G₂ and G₃ are selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

<9> The process according to any one of <1> to <8>, wherein the diamine monomers are selected from the group consisting of 4,4′-diamino-2,2′-bistrifluoromethylbenzidine, 9,9-bis(4-aminophenyl)fluorene, 9,9-bis(3-fluoro-4-aminophenyl)fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, 3,5-diaminobenzoic acid, bis(4-aminophenyl)sulfone (DDS), and a combination thereof.

<10> The process according to any one of <1> to <9>, wherein the step (a) is conducted in the absence of an amide-based solvent.

<11> The process according to any one of <4> to <10>, wherein the amide-based organic solvent is selected from the group consisting of N,N-dimethylacetamide (DMAc), N-methyl-2-pyrrolidone (NMP), N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, and a combination thereof.

<12> The process according to any one of <4> to <11>, wherein the non-amide-based organic solvent is γ-butyrolactone, α-methyl-γ-butyrolactone, or a mixture thereof.

<13> A polyamide solution manufactured by the process according to any one of <1> to <12>.

<14> A process for manufacturing a display element, an optical element, an illumination element or a sensor element, comprising steps of

(I) applying a polyamide solution on a base to form a film, the solution being obtained or obtainable by the process according to any one of <1> to <12>; and

(II) forming the display element, the optical element, the illumination element, or the sensor element on one surface of the polyamide film.

<15> The process according to <14>, further comprising a step of de-bonding the formed display element, the optical element, the illumination element or the sensor element from the base.

[Example of First Manufacturing Process (Physical Removal)]

To a 250 ml three-necked round-bottom flask, equipped with a mechanical stirrer, a nitrogen inlet, an outlet and a reduced-pressure line connected to a vacuum pump, are added DDS (11.92 g, 0.048 mol), FDA (3.14 g, 0.0090 mol), DAB (0.456 g, 0.0030 mol) and GBL (100 ml). After the DDS, the FDA and the DAB are dissolved completely, the solution is cooled to 5° C. Later, the system is decompressed to 3.0 kPa. To this solution, another solution prepared by dissolving TPC (3.65 g, 0.018 mol) and IPC (8.44 g, 0.042 ml) in GBL (95 ml) while stirring is added by use of a dropping funnel. After two hours, the solution is heated to 50° C. After two hours, benzoyl chloride (0.12 g, 0.84 mmol) is added to the solution, and the solution is stirred for further two hours so as to obtain a polyamide solution.

[Example of Second Manufacturing Process (Removal by Use of Base)]

To a 250 ml three-necked round-bottom flask, equipped with a mechanical stirrer, a nitrogen inlet and an outlet, are added DDS (9.93 g, 0.040 mol), FDA (2.61 g, 0.0075 mol), DAB (0.38 g, 0.0025 mol) and DMAc (152 ml). After the DDS, the FDA and the DAB are dissolved completely, triethylamine (20.24 g, 0.2 mol) is added to the thus prepared solution. The solution is cooled to 0° C. To the solution, TPC (3.05 g, 0.015 mol) and IPC (7.03 g, 0.035 mol) are added while stirring. The inner wall of the flask is cleaned with DMAc (10 ml). After two hours, benzoyl chloride (0.049 g, 0.35 mmol) is added to the solution, and the solution is stirred for further two hours, and triethylamine hydrochloride generated as a result of a reaction is removed by filtering so as to obtain a polyamide solution.

The embodiments have been described, hereinabove. It will be apparent to those skilled in the art that the above methods and apparatuses may incorporate changes and modifications without departing from the general scope of this disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of this disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A process for manufacturing polyamide, comprising steps of:
(a) reacting a diacid dichloride monomer with at least two kinds of diamine monomers in a solvent so as to generate polyamide; and
(b) removing hydrochloric acid physically out of a reaction system, the hydrochloric acid being generated during the reaction in the step (a),
wherein at least one of the diamine monomers is a diamine monomer containing a carboxyl group.

2. The process according to claim 1, wherein the solvent is a non-amide based organic solvent, an amide-based organic solvent, or a combination thereof.

3. The process according to claim 1, wherein the polyamide is obtained as a polyamide solution where the polyamide is dissolved in a solvent.

4. The process according to claim 1, wherein the diacid dichloride monomer is selected from the group consisting of: 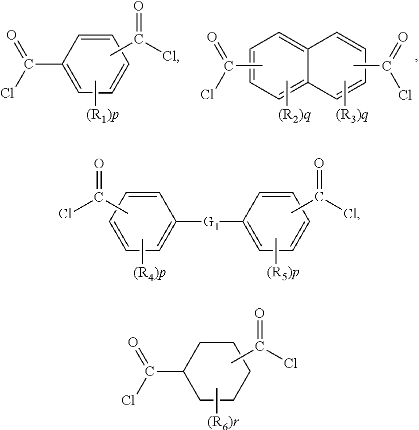
and a combination thereof,
wherein p=4, q=3, r=10, and wherein R₁, R₂, R₃, R₄, R₅ and R₆ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof,
wherein G₁ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

5. The process according to claim 1, wherein the diacid dichloride monomer is selected from the group consisting of terephthaloyl dichloride, isophthaloyl dichloride, 2,6-naphthaloyl dichloride, 4,4′-biphenyldicarbonyl dichloride, tetrahydro terephthaloyl dichloride and a combination thereof.

6. The process according to claim 1, wherein the diamine monomers are selected from the group consisting of: 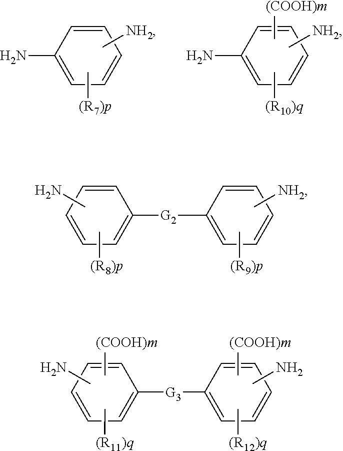
and a combination thereof,
wherein p=4, q=2 or 3, m=1 or 2, and wherein R₇, R₈, R₉, R₁₀, R₁₁ and R₁₂ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof,
wherein G₂ and G₃ are selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

7. The process according to claim 1, wherein the diamine monomers are selected from the group consisting of 4,4′-diamino-2,2′-bistrifluoromethylbenzidine, 9,9-bis(4-aminophenyl)fluorene, 9,9-bis(3-fluoro-4-aminophenyl)fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, 3,5-diaminobenzoic acid, bis(4-aminophenyl)sulfone (DDS), and a combination thereof.

8. The process according to claim 1, wherein the step (a) is conducted in the absence of an amide-based solvent.

9. The process according to claim 2, wherein the amide-based organic solvent is selected from the group consisting of N,N-dimethylacetamide (DMAc), N-methyl-2-pyrrolidone (NMP), N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, and a combination thereof.

10. The process according to claim 2, wherein the non-amide-based organic solvent is γ-butyrolactone, α-methyl-γ-butyrolactone, or a mixture thereof.

11. A process for manufacturing polyamide, comprising steps of:
(a) reacting a diacid dichloride monomer with at least two kinds of diamine monomers in a solvent so as to generate polyamide; and
(c) adding a trapping reagent capable of trapping hydrochloric acid, at any time at least before the step (a), at the same time of starting the step (a), or during the step (a),
wherein at least one of the diamine monomers is a diamine monomer containing a carboxyl group, and
the trapping reagent contains no propylene oxide.

12. The process according to claim 11, wherein the trapping reagent is either an organic base or an inorganic base.

13. The process according to claim 11, wherein the solvent is a non-amide-based organic solvent, an amide-based organic solvent, or a combination thereof.

14. The process according to claim 11, wherein the polyamide is obtained as a polyamide solution where the polyamide is dissolved in a solvent.

15. The process according to claim 11, wherein the diacid dichloride monomer is selected from the group consisting of: 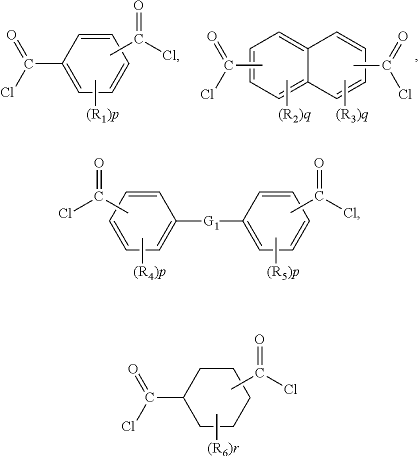
and a combination thereof,
wherein p=4, q=3, r=10, and wherein R₁, R₂, R₃, R₄, R₅ and R₆ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof,
wherein G₁ is selected from the group consisting of a covalent bond; a CH₂ group; a C(CH₃)₂ group; a C(CF₃)₂ group; a C(CX ₃)₂ group, where Xis a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

16. The process according to claim 11, wherein the diacid dichloride monomer is selected from the group consisting of terephthaloyl dichloride, isophthaloyl dichloride, 2,6-naphthaloyl dichloride, 4,4′-biphenyldicarbonyl dichloride, tetrahydro terephthaloyl dichloride and a combination thereof.

17. The process according to claim 11, wherein the diamine monomers are selected from the group consisting of: 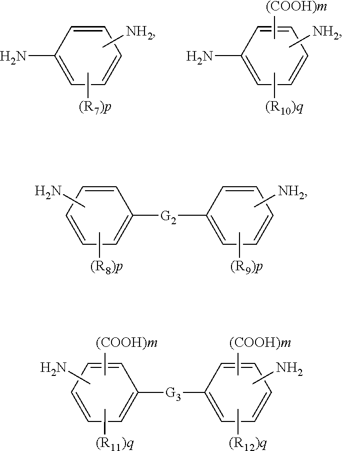
and a combination thereof,
wherein p=4, q=2 or 3, m=1 or 2, and wherein R₇, R₈, R₉, R₁₀, R₁₁ and R₁₂ are selected from the group consisting of hydrogen, halogen, alkyl, substituted alkyl, nitro, cyano, thioalkyl, alkoxy, substituted alkcoxy, aryl, substituted aryl, alkyl ester, substituted alkyl ester, and combinations thereof,
wherein G₂ and G₃ are selected from the group consisting of a covalent bond; a CH₂ group; a C(CH₃)₂ group; a C(CF₃)₂ group; a C(CX₃)₂ group, where X is a halogen; a CO group; an Oatom; a S atom; a SO₂ group; a Si(CH₃)₂ group; a 9,9-fluorene group; a substituted 9,9-fluorene group; and an OZO group, where Z is an aryl group or a substituted aryl group.

18. The process according to claim 11, wherein the diamine monomers are selected from the group consisting of 4,4′-diamino-2,2′-bistrifluoromethylbenzidine, 9,9-bis(4-aminophenyl)fluorene, 9,9-bis(3-fluoro-4-aminophenyl)fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, 3,5-diaminobenzoic acid, bis(4-aminophenyl)sulfone (DDS), and a combination thereof.

19. The process according to claim 11, wherein the step (a) is conducted in the absence of an amide-based solvent.

20. The process according to claim 13, wherein the amide-based organic solvent is selected from the group consisting of N,N-dimethylacetamide (DMAc), N-methyl-2-pyrrolidone (NMP), N,N-dimethylformamide (DMF), 3-methoxy-N,N-dimethylpropionamide, 3-butoxy-N,N-dimethylpropanamide, 1-ethyl-2-pyrrolidone, N,N-dimethylpropionamide, N,N-dimethylbutyramide, N,N-diethylacetamide, N,N-diethylpropionamide, 1-methyl-2-piperidinone, and a combination thereof.

21. The process according to claim 13, wherein the non-amide-based organic solvent is γ-butyrolactone, αmethyl-γ-butyrolactone, or a mixture thereof.

22. A process for manufacturing a display element, an optical element, an illumination element or a sensor element, comprising steps of:
(I) applying a polyamide solution on a base to form a film, the solution being obtained or obtainable by the process according to claim 1; and
(II) forming the display element, the optical element, the illumination element, or the sensor element on one surface of the polyamide film.

23. The process according to claim 22, further comprising a step of de-bonding the formed display element, the optical element, the illumination element or the sensor element from the base.
